(19) United States
(12) Patent Application Publication
(10) Pub. No.: US 2005/0180005 A1
(43) Pub. Date: Aug. 18, 2005

(54) Screen and projection system including the same

(75) Inventors: Gyu-hwan Hwang, Hwaseong-si (KR); Seok-il Yoon, Daejeon (KR); Young-il Kah, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/008,127

(22) Filed: Dec. 10, 2004

(30) Foreign Application Priority Data
Dec. 10, 2003 (KR) 2003-89351

(51) Int. Cl. G03B 21/60

(52) U.S. Cl. 359/457

(57) ABSTRACT

A screen having improved contrast, a wide viewing angle, and uniform luminosity and a projection system including the screen are provided. The screen includes a Fresnel lens sheet, a lenticular lens sheet including first cylindrical lenses extending vertically and formed on a surface of the lenticular lens sheet, and a protective sheet including second cylindrical lenses. The second cylindrical lenses extend horizontally and are formed on a surface of the protective sheet. A tinted layer is formed on surfaces of the second cylindrical lenses. The projection system forms on an image on the screen. The image is generated by a display device and magnified and projected by a projection lens unit. Therefore, a viewer can watch the projection system from an angle wider than that provided by conventional projection systems.

### BACKGROUND OF THE INVENTION

This application claims the priority of Korean Patent Application No. 2003-89351, filed on Dec. 10, 2003, in the Korean Intellectual Property Office, the disclosure of which is incorporated herein in its entirety by reference.

1. Field of the Invention

The present invention relates to a screen having improved contrast, a wide viewing angle, and uniform luminosity, and a projection system including the screen.

2. Description of the Related Art

An image projection system such as a projection television and a video projector generates an image using a specially manufactured image display medium such as a small CRT, an LCD, or a PDLC, magnifies the image using a projection lens, and projects the magnified image on a large screen. The image projection system has the advantage of providing a large screen. Since consumers prefer large screens, the demand for image projection systems is growing.

An image projection system may be a front projection system or a rear projection system depending on how an image is magnified and projected on a screen. Regardless of its type, an image projection system projects a light beam, emitted from a light source, toward a screen to form an image on the screen such that a viewer in front of the screen can recognize the image. Preferably, a viewer is centered in front of the screen. However, the viewer may not be centered in front of the screen and the screen may be above or below eye level. Therefore, the image projection systems must have a wide viewing angle.

FIG. 1 is a schematic view of a conventional projection television. Referring to FIG. 1, the conventional projection television includes a cabinet 10, a screen 20, a display device 11, a projection lens unit 13, and a reflector 15. The screen 20 is installed on the front surface of the cabinet 10, and an image is formed thereon. The display device 11, such as a CRT, is located inside the cabinet 10 and forms an image and sends the image toward the reflector 15. The projection lens unit 13 magnifies the image sent from the display device 11, and the reflector 15 reflects the image toward the screen 20.

Thus, the image is projected on the rear surface of the screen 20, and a viewer, in front of the screen 20, watches the image projected on the screen.

FIG. 2 is an exploded perspective view of a conventional screen.

Referring to FIGS. 1 and 2, the screen 20 includes a Fresnel lens sheet 41, a first lenticular lens 43, and a protective sheet 50. The Fresnel lens sheet 41 refracts a light beam reflected by the reflector 15 to collimate the light beam. The first lenticular lens 43 disposed in front of the Fresnel lens sheet 41 widens an image passed through the Fresnel lens sheet 41 in a horizontal direction, thereby widening a horizontal viewing angle. The protective sheet 50 is disposed in front of the first lenticular lens 43 and protects the Fresnel lens sheet 41 and the first lenticular lens 43.

The protective sheet 50 includes a first protective substrate 51 protecting the first lenticular lens 43, a lens array 52 formed on an incident surface of the first protective sheet 51, and an external light reflection reducer 55 attached to an exit surface of the first protective substrate 51. The external light reflection reducer 55 prevents a light beam emitted from an external light source such as a fluorescent lamp from being reflected at the surface of the first substrate 51.

The first lenticular lens provides a wide horizontal viewing angle (X direction) while the lens array 52 provides a vertical viewing angle (Y direction).

To secure wide vertical and horizontal viewing angles, Japanese Patent Laid-open Publication No. 2000-137293, published on May 16, 2000, and entitled “Transmission screen,” provides a conventional screen that secures wide vertical and horizontal viewing angles.

FIG. 3 is an exploded perspective view of the screen disclosed in this publication. Referring to FIG. 3, the screen includes a Fresnel lens sheet 60 and a lenticular lens 62. A lens array 60a extending horizontally is disposed on an incident surface of the Fresnel lens sheet 60, and a Fresnel lens 60b is formed on an exit surface of the Fresnel lens sheet 60. Another lens array 62a is formed on an incident surface of the lenticular lens 62, and black stripes 62b are formed on an exit surface of the lenticular lens 62.

The lens array 60a of the Fresnel lens sheet 60 diffuses a light beam in a vertical direction, thereby securing a vertical viewing angle of the screen. To have a vertical viewing angle as large as a horizontal viewing angle, each of the lens arrays 60a and 62a needs to have a large curvature. However, a large curvature causes a focusing problem, thereby degrading image quality.

As a solution to this problem, power may be increased. However, in this case, a diffused light beam is incident on the Fresnel lens sheet 60, resulting in degradation of resolution and forming of multiple images. Therefore, watching the screen becomes difficult.

FIG. 4 is a graph illustrating vertical and horizontal angles of light after passing through the conventional screen of FIG. 3. A first curve g1 illustrates luminosity G with respect to a horizontal viewing angle OH, and a second curve g2 illustrates luminosity G with respect to a vertical viewing angle θ_{V}. Referring to FIG. 4, the vertical viewing angle θ_{V} is smaller than the horizontal viewing angle θ_{H}.

### SUMMARY OF THE INVENTION

The present invention provides a screen widened vertical and horizontal viewing angles and increased luminosity, and a projection system including the screen.

According to an aspect of the present invention, there is provided a screen including a Fresnel lens sheet; a lenticular lens sheet including first cylindrical lenses extending vertically and formed on a surface of the lenticular lens sheet; and a protective sheet including second cylindrical lenses extending horizontally and formed on a surface of the protective sheet, and a tinted layer formed on surfaces of the second cylindrical lenses.

The second cylindrical lenses may have curvatures that change according to their vertical position on the surface of the protective sheet. The curvatures of the second cylindrical lenses may become smaller toward a center of the screen.

According to another aspect of the present invention, there is provided a screen including a Fresnel lens sheet; a lenticular lens sheet including cylindrical lenses extending vertically and formed on a surface of the lenticular lens sheet; and a protective sheet including prisms extending horizontally and formed on a surface of the protective sheet, and a tinted layer formed on surfaces of the prisms.

The prisms may have angles that change according to their vertical position on the surface of the protective sheet.

According to another aspect of the present invention, there is provided a projection system including a display device which generates an image, a projection lens unit which magnifies and projects the image, and a screen on which the image is formed. The screen includes a Fresnel lens sheet; a lenticular lens sheet including first cylindrical lenses extending vertically and formed on a surface of the lenticular lens sheet; and a protective sheet including second cylindrical lenses extending horizontally and formed on a surface of the protective sheet, and a tinted layer formed on surfaces of the second cylindrical lenses.

According to another aspect of the present invention, there is provided a projection system including a display device which generates an image, a projection lens unit which magnifies and projects the image, and a screen on which the image generated is formed. The screen includes a Fresnel lens sheet; a lenticular lens sheet including cylindrical lenses extending vertically and formed on a surface of the lenticular lens sheet; and a protective sheet including prisms extending horizontally and formed a surface of the protective sheet, and a tinted layer formed on surfaces of the prisms.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional projection television;

FIG. 2 is an exploded perspective view of a conventional screen;

FIG. 3 is an exploded perspective view of a conventional screen disclosed in Japanese Patent Publication No. 2000-137293;

FIG. 4 is a graph illustrating vertical and horizontal angles of light after passing through the conventional screen of FIG. 3;

FIG. 5 is an exploded perspective view of a screen according to a first embodiment of the present invention;

FIG. 6A is a side view of the screen of FIG. 5;

FIG. 6B is an enlarged view of a protective sheet illustrated in FIG. 6A;

FIG. 7A is a graph illustrating an exit angle of a light beam with respect to a vertical position of the screen of FIG. 5;

FIG. 7B is a graph illustrating luminosity with respect to the vertical viewing angle of the screen of FIG. 5;

FIG. 8 is a cross sectional view of the screen taken along line VIII-VIII of FIG. 6A;

FIG. 9A is a side view of a screen according to a second embodiment of the present invention;

FIG. 9B is an enlarged view of a protective sheet illustrated in FIG. 9A;

FIG. 10 is a side view of a screen according to a third embodiment of the present invention;

FIG. 11A is a schematic view of a projection system according to a first embodiment of the present invention;

FIG. 11B is a schematic view of a projection system according to a second embodiment of the present invention; and

FIG. 11C is a schematic view of a projection system according to a third embodiment of the present invention.

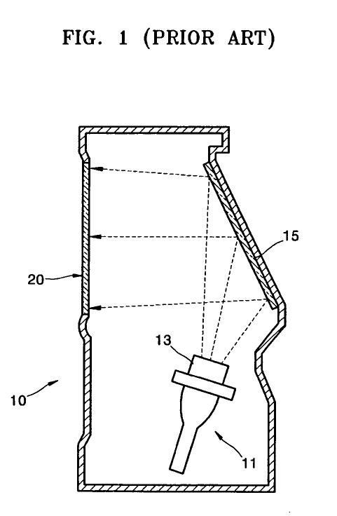

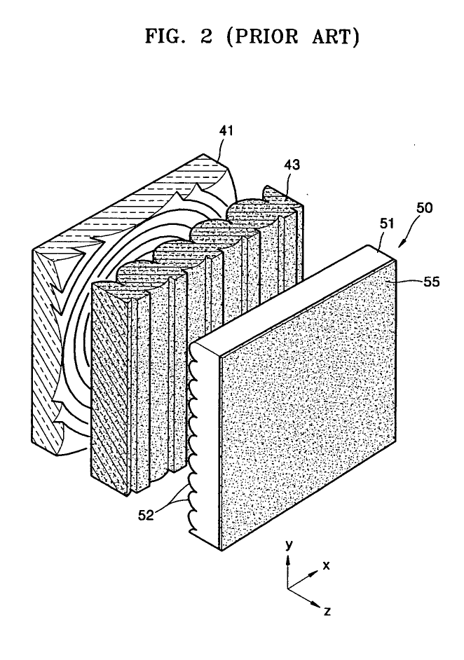

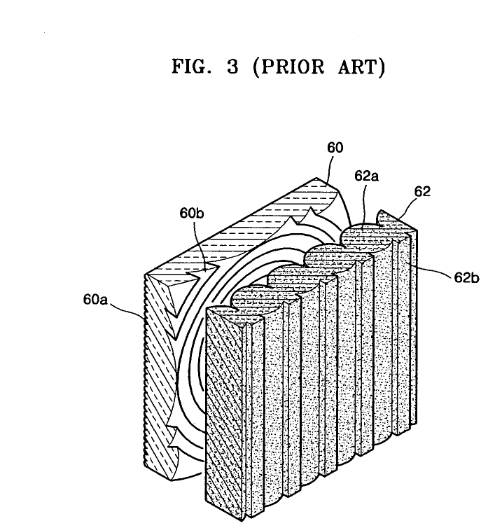

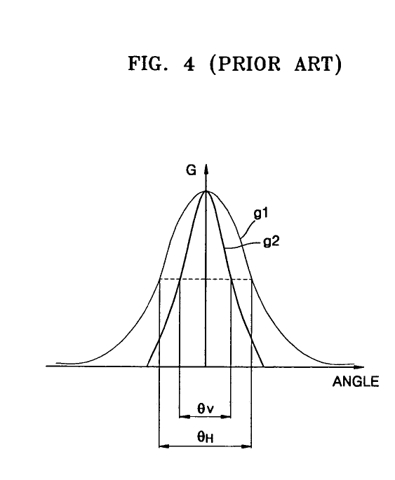

### DETAILED DESCRIPTION OF THE INVENTION

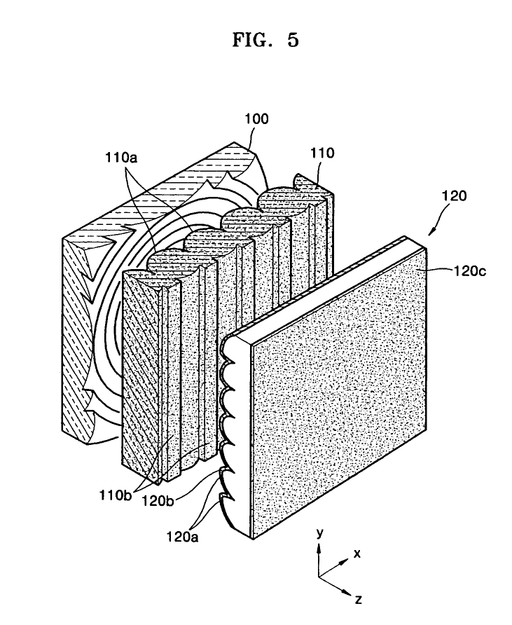

FIG. 5 is an exploded perspective view of a screen according to a first embodiment of the present invention. Referring to FIG. 5, the screen includes a Fresnel lens sheet 100, a lenticular lens sheet 110, and a protective sheet 120. The Fresnel lens sheet 100 collimates an incident light beam, which is incident on the lenticular lens sheet 110. The Fresnel lens sheet 100 is formed of a polymethyl methacrylate (PMMA) plate using a ultraviolet-hardened resin and has a predetermined pitch. The Fresnel lens sheet 100 forms multiple focuses to facilitate many viewing distances.

Although not shown in the drawing, a plurality of patterns widening a vertical viewing angle (Y direction) may be formed in a predetermined shape on the rear surface of the Fresnel lens sheet 100. The plurality of patterns may be identical, and each of the patterns may comprise a horizontally disposed cylindrical lens.

The lenticular lens sheet 110 disposed in front of the Fresnel lens sheet 100 spreads the light beam emitted from the Fresnel lens sheet 100 in a horizontal direction (X direction), thereby widening a horizontal viewing angle. The lenticular lens sheet 110 includes first cylindrical lenses 110a on its incident or exit surface in a direction (Y direction) and black stripes 110b formed on its remaining surface. The black stripes 110b absorb a radiating light beam and block an external light beam incident from an external source, thereby increasing a contrast ratio of the screen.

The protective sheet 120 is disposed in front of the lenticular lens sheet 110. The protective sheet 120 includes second cylindrical lenses 120a formed on its incident surface in a direction horizontal of the screen. A tinted layer 120b is formed on the surfaces of the second cylindrical lenses 120a to minimize external reflection by appropriately absorbing the external light beam, thereby preventing degradation of a contrast ratio and luminosity.

The tinted layer 120b may be composed of an optical resin having a high light transmission coefficient such as PET (polyethylene terephthalate), PC (polycarbonate), or PMMA (polymethyl methacrylate) or an alloy of PET, PC, or PMMA.

Meanwhile, the protective sheet 120 may be formed in a variety of ways. For example, a resin formed by double extruding or an ultraviolet-hardened resin may be used. In the double extruding method, the protective sheet 120 and the second cylindrical lenses 120a are extruded. In the extruding process, only the tinted layer 120b is tinted.

When using ultraviolet-hardened resin, the second cylindrical lenses 120a are formed of the ultraviolet-hardened resin. In this case, tinting is concentrated on a portion of the surface of the protective sheet 120 on which the second cylindrical lenses 120a are formed.

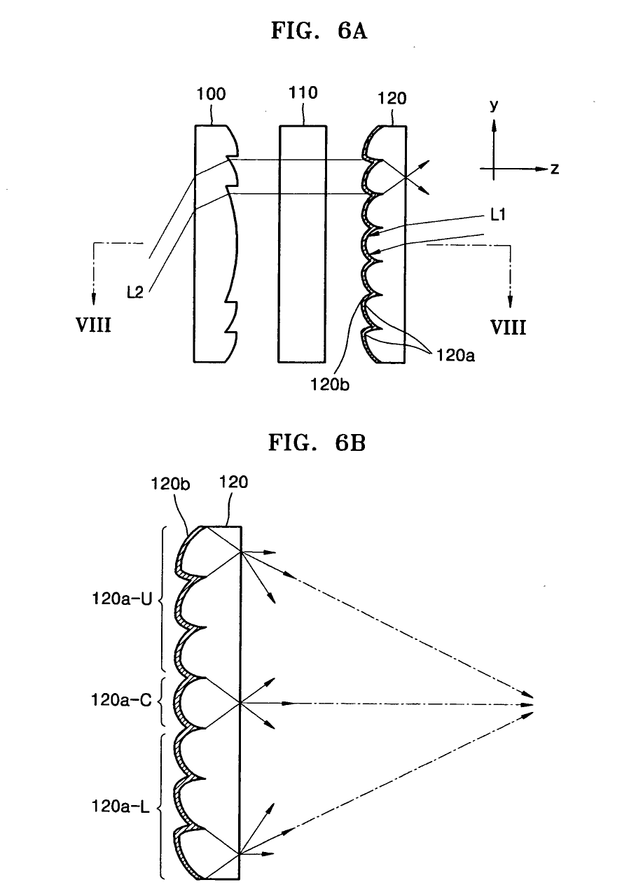

FIG. 6A is a side view of the screen of FIG. 5. FIG. 6B is an enlarged view of the protective sheet 120 illustrated in FIG. 6A. Referring to FIG. 6B, the second cylindrical lenses 120a includes upper second cylindrical lenses 120a-U, central second cylindrical lenses 120a-C, and lower second cylindrical lenses 120a-L, which are formed on the upper, central, and lower parts of the protective sheet 120, respectively.

The second cylindrical lenses 120a are tilted toward the center of the protective sheet 120. The upper second cylindrical lenses 120a-U are tilted downward and toward the center of the protective sheet 120. The lower second cylindrical lenses 120a-L are tilted upward and toward the center of the protective sheet 120. The central second cylindrical lenses 120a-C are not tilted. The upper second cylindrical lenses 120a-U and the lower second cylindrical lenses 120a-L may be symmetrical.

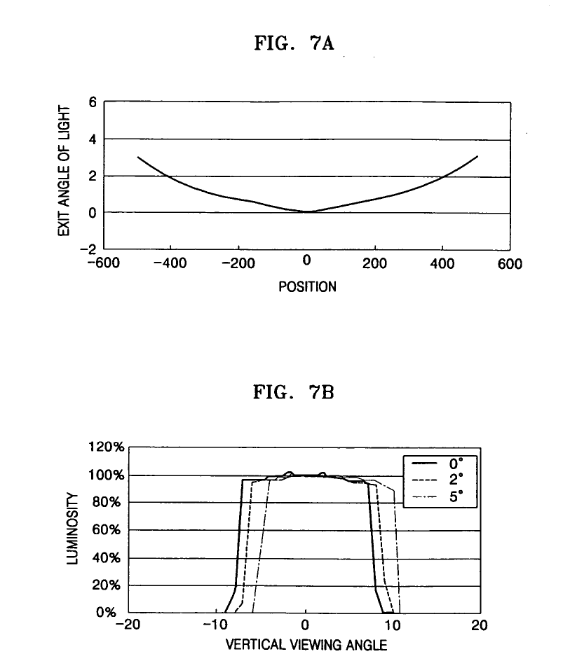

FIG. 7A is a graph illustrating an exit angle of a light beam with respect to a vertical position of the screen of FIG. 5 when the second cylindrical lenses 120a are tilted as described above. Referring to the graph, the exit angle of the light beam varies according to the vertical position of the screen, and the exit angles are symmetrical with respect to center line.

FIG. 7B is a graph illustrating luminosity with respect to a vertical viewing angle of the screen when tilted angles of the second cylindrical lenses 120a are 0, 2, and 5 degrees. Referring to the graph, luminosity is distributed evenly and the vertical viewing angle of the screen changes according to the tilted angles of the second cylindrical lenses 120a. By tilting the second cylindrical lenses 120a according to the vertical position of the screen, the vertical viewing angle and uniform luminosity can be secured.

The protective sheet 120 protects the screen and prevents static electricity, external scratches, and scattered reflection from an external light beam. The tinted layer 120b formed on the second cylindrical lenses 120a prevents external reflection by appropriately absorbing the external light beam, thereby enhancing the efficiency of light transmittance and preventing degradation of the contrast ratio of the screen.

Referring back to FIG. 6A, a first light beam L1 incident on the front surface of the protective sheet 120 passes through the protective sheet 120 and is incident on the tinted layer 120b. The second cylindrical lenses 120a have a predetermined curvature such that total internal reflection of the first light beam L1 incident thereon can occur. The tinted layer 120b attached to the surfaces of the second cylindrical lenses 120a forms cylindrical lenses having the same curvature as the second cylindrical lenses 120a. The first light beam L1 is totally reflected at an outer surface of the protective sheet 120 and proceeds inside the protective sheet 120. Then, the first light beam L1 is again completely reflected at another portion of the outer surface of the protective sheet 120 and proceeds toward internal of the protective sheet 120. In this process, most of the first light beam L1 is absorbed by the protective sheet 120. In this regard, most of the first light beam L1 does not transmit through the protective sheet 120, and the effect of the first light beam L1 incident on the protective sheet 120 is negligible.

Meanwhile, the amount of the second light beam L2, originating from the display device 11, absorbed by the tinted layer 120b is very low when the second light beam L2 travels a short distance through the tinted later 120b. Hence, the effects of the tinted layer 120b on the second light beam L2 are negligible.

In other words, the tinted layer 120b does not affect an image formed by a display device such as a CRT and an LCD. However, the tinted layer 120b does absorb most of the first light beam L1, that is, a light beam incident from an external source. Therefore, the screen of a projection television including the tinted layer 120b has a greater contrast ratio and is brighter than conventional screens.

In the meantime, as shown in FIG. 5, a reflection preventive coating layer 120c may also be formed on a surface of the protective sheet 120b facing a viewer to prevent degradation of image quality due to an external light beam.

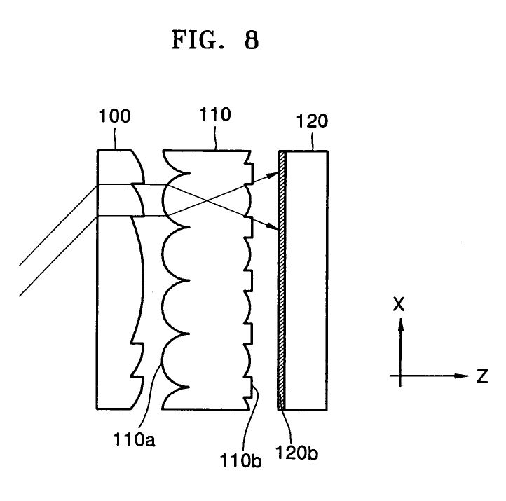

FIG. 8 is a cross sectional view of the screen taken along a line VIII-VIII of FIG. 6A. Referring to FIG. 8, the Fresnel lens sheet 100 collimates a light beam, which is incident on the lenticular lens sheet 110. When the light beam passes through the lenticular lens sheet 110, the first cylindrical lenses 110a of the lenticular lens sheet 110 widen a horizontal viewing angle of the light beam. The black stripes 110b absorb a radiating light beam and block an external light beam incident from an external source, thereby increasing the contrast ratio of the screen.

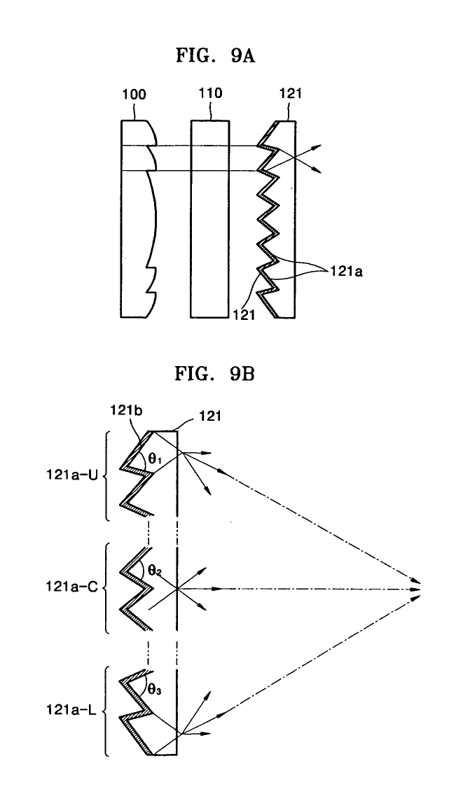

FIG. 9A is a side view of a screen according to a second embodiment of the present invention. Referring to FIG. 9A, the screen includes a plurality of prisms 121a formed on one side of a protective sheet 121 to compensate for luminosity in the upper and the lower parts of the screen where luminosity is lower than the other parts of the screen. A detailed description of a Fresnel lens sheet 100 and a lenticular lens sheet 110 will be omitted since they are identical to those of FIG. 5, which have already been described.

FIG. 9B is an enlarged view of the protective sheet 121 illustrated in FIG. 9A. Referring to FIG. 9B, the prisms 121a include upper prisms 121a-U, central prisms 121a-C, and lower prisms 121a-L, which are disposed in the upper, the central, and the lower parts of the protective sheet 121.

The prisms 121a are tilted toward the center of the protective sheet 121 according to a height of the screen. The angles of the prisms 121a may be identical or different. The lower prisms 121a-L and the upper prisms 121a-U may be symmetrical about a center-line of the protective sheet 121.

A tinted layer 121b is formed on a surface of the protective sheet 121 where the prisms 121a are formed. As described above, the tinted layer 121b absorbs an external light beam, thereby preventing degradation of a contrast ratio.

Although not shown in the drawing, the configurations of the screens according to the first and the second embodiments of the present invention may be modified as long as they are within the scope of the present invention. For example, a light diffuser may be added to the lenticular lens sheet 110 or to the protective sheets 120 and 121. In addition, a small heat transmitter or a cooler may be connected to the screens to eliminate heat generated by the tinted layers 120b and 121b absorbing external light. Further, the tinted layers 120b and 121b may selectively cover only a portion of the protective sheets 120 and 121.

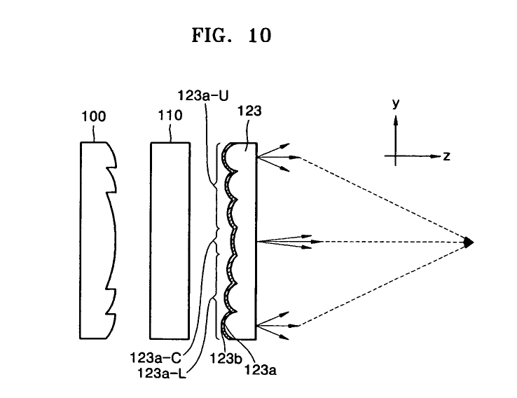

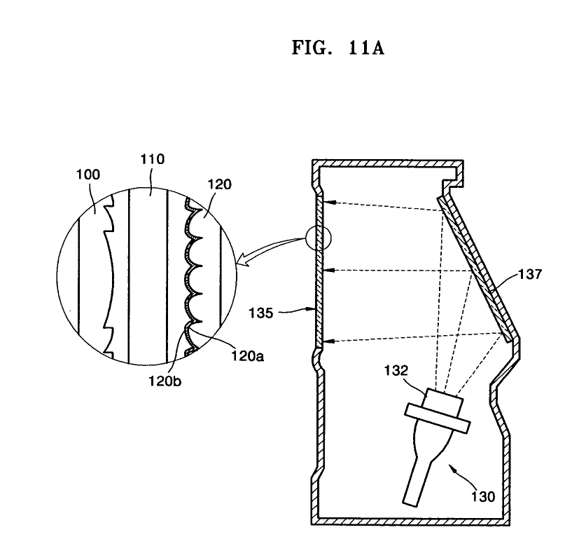

FIG. 10 is a side view of a screen according to a third embodiment of the present invention. Referring to FIG. 10, the screen includes a plurality of cylindrical lenses 123a on one side of a protective sheet 123 to compensate for luminosity in the upper and the lower parts of the screen where luminosity is lower than the other parts of the screen. The cylindrical lenses 123a have different curvatures according to the height of the screen. A detailed description of a Fresnel lens sheet 100 and a lenticular lens sheet 110 will be omitted since they are identical to those of FIG. 5, which have already been described.

The cylindrical lenses 123a include upper cylindrical lenses 123a-U, central cylindrical lenses 123a-C, and lower cylindrical lenses 123a-L, the curvature of each of which becomes smaller toward the center of the protective sheet 121. In other words, the closer to the center of the protective sheet 123, the larger radiuses of the curvatures of the cylindrical lenses 123a.

The curvatures of the upper cylindrical lenses 123a-U and the lower cylindrical lenses 123a-L are larger than those of the central cylindrical lenses 123a-C. In addition, the upper and the lower cylindrical lenses 123a-U and 123a-L may be symmetrical such that an exit angle of a light beam emitted from the upper and the lower parts of the screen is larger than that of a light beam emitted from the central part of the screen, thereby improving luminosity and contrast.

Meanwhile, a tinted layer 123b is formed on the cylindrical lenses 123a. The tinted layer 123b prevents degradation of the contrast by absorbing an external light beam.

A projection system including a screen according to an embodiment of the present invention will now be described.

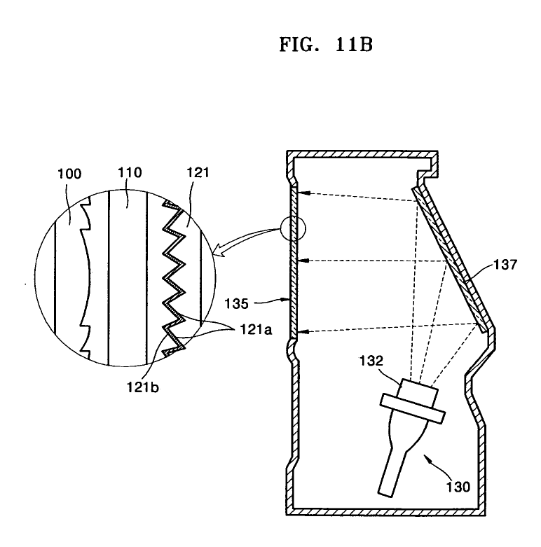

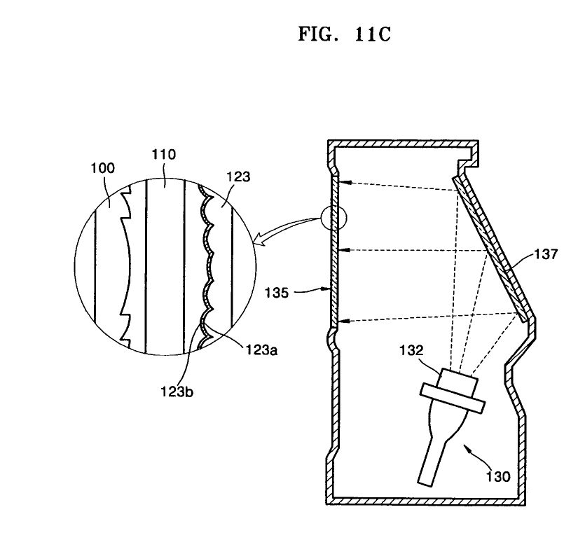

FIG. 11A is a schematic view of a projection system according to a first embodiment of the present invention. Referring to FIG. 11A, the projection system includes a display device 130, a projection lens unit 132 magnifying an image generated by the display device 130 and projecting the magnified image, and a screen 135 on which the image projected by the projection lens unit 132 is formed.

As described with reference to FIG. 5, the screen 135 includes a Fresnel lens sheet 100, a lenticular lens sheet 110 widening a vertical viewing angle, and a protective sheet 120 widening a horizontal viewing angle and protecting the screen 135. The protective sheet 120 includes cylindrical lenses 120a tilted toward the center of the screen 135, and a tinted layer 120b is formed on the surfaces of the cylindrical lenses 120a.

The screen 135 may further include a reflector 137 converting an optical path such that the image magnified and projected by the projection lens unit 132 can be displayed on the screen 135.

FIG. 11B is a schematic view of a projection system according to a second embodiment of the present invention. Referring to FIG. 11B, the projection system includes a screen 135 including a Fresnel lens sheet 100, a lenticular lens sheet 110 widening a vertical viewing angle, and a protective sheet 121 widening a horizontal viewing angle and protecting the screen 135. The protective sheet 121 is disposed in a direction perpendicular to the screen 135 and includes prisms 121a having angles that become larger toward the center of the screen 135. A tinted layer 121b absorbing an external light beam is formed on the surfaces of the prisms 121a. The cylindrical lenses 120a and the prisms 121a have an advantage of being able to provide uniform luminosity and a vertical viewing angle.

FIG. 11C is a schematic view of a projection system according to a third embodiment of the present invention. Referring to FIG. 11C, the projection system includes a screen 135 including a Fresnel lens sheet 100, a lenticular lens sheet 110 widening a vertical viewing angle, and a protective sheet 123 widening a horizontal viewing angle and protecting the screen. The protective sheet 123 includes cylindrical lenses 123a whose curvatures change according to the height of the screen 135 and a tinted layer 123b formed on the surfaces of the cylindrical lenses 123a.

The projection system according to the exemplary embodiments of the present invention has wide horizontal and vertical viewing angles and eliminates the concerns about degradation of contrast due to the wide viewing angles. Moreover, uniform luminosity is secured, and a viewer can watch the projection system from wide angles.

As described above, in a screen according to an embodiment of the present invention, cylindrical lenses widening a vertical viewing angle are tilted or their curvatures are changed, or prisms are tilted to secure a viewing angle at the corners and in the upper and the lower parts of the screen where luminosity is relatively lower than the other parts of the screen. Therefore, uniform luminosity can be secured across the entire screen.

In the present invention, a tinted layer is included to secure the horizontal and the vertical viewing angles and prevent degradation of contrast due to the wide vertical viewing angle.

The projection television including the screen according to an embodiment of the present invention enables a viewer to watch the projection television from an angle wider than that provided by conventional projection systems.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image display screen comprising:
a Fresnel lens sheet;
a lenticular lens sheet comprising first cylindrical lenses extending vertically and formed on a surface of the lenticular lens sheet; and
a protective sheet comprising:
second cylindrical lenses extending horizontally and formed on a surface of the protective sheet, and
a tinted layer formed on surfaces of the second cylindrical lenses.

2. The image display screen of claim 1, wherein the second cylindrical lenses are tilted according to their vertical position on the surface of the protective sheet.

3. The image display screen of claim 1, wherein the second cylindrical lenses have curvatures that change according to their vertical position on the surface of the protective sheet.

4. The image display screen of claim 3, wherein the curvatures of the second cylindrical lenses are smaller for those of the second cylindrical lenses disposed toward the center of the protective sheet.

5. The image display screen of claim 3, wherein the second cylindrical lenses comprise upper second cylindrical lenses, lower second cylindrical lenses, and central cylindrical lenses, and the upper cylindrical lenses and the lower cylindrical lenses have symmetrical curvatures.

6. An image display screen comprising:
a Fresnel lens sheet;
a lenticular lens sheet comprising cylindrical lenses extending vertically and formed on a surface of the lenticular lens sheet; and
a protective sheet comprising:
prisms extending horizontally and are formed on a surface of the protective sheet, and
a tinted layer formed on surfaces of the prisms.

7. The image display screen of claim 6, wherein the prisms are tilted according to their vertical position on the surface of the protective sheet.

8. The image display screen of claim 6, wherein the prisms have angles that change according to their vertical position on the surface of the protective sheet.

9. The image display screen of claim 8, wherein the prisms comprise upper prisms, lower prisms, and central prisms, and the upper prisms and the lower prisms have symmetrical angles about a center line of the protective sheet.

10. A projection system comprising:
a display device which generates an image;
a protection lens unit which magnifies and projects the image; and
a screen on which the image is formed, comprising:
a Fresnel lens sheet;
a lenticular lens sheet comprising first cylindrical lenses extending vertically and formed on a surface of the lenticular lens sheet, and
a protective sheet comprising
second cylindrical lenses extending horizontally and formed on a surface of the protective sheet, and
a tinted layer formed on surfaces of the second cylindrical lenses.

11. The projection system of claim 10, wherein the second cylindrical lenses are tilted according to their vertical position on the surface of the protective sheet.

12. The projection system of claim 10, wherein the second cylindrical lenses have curvatures that change according to their vertical position on the surface of the protective sheet.

13. The projection system of claim 12, wherein the curvatures of the second cylindrical lenses are smaller for those of the second cylindrical lenses disposed toward the center of the protective sheet.

14. A projection system comprising:
a display device which generates an image;
a protection lens unit which magnifies and projects the image; and
a screen on which the image is formed, comprising:
a Fresnel lens sheet;
a lenticular lens sheet comprising cylindrical lenses extending vertically and formed on a surface of the lenticular lens sheet; and
a protective sheet comprising
prisms extending horizontally and formed a surface of the protective sheet, and
a tinted layer formed on surfaces of the prisms.

15. The projection system of claim 14, wherein the prisms are tilted according to their vertical position on the surface of the protective sheet.
